(19) United States
(12) Patent Application Publication
(10) Pub. No.: US 2011/0223568 A1
(43) Pub. Date: Sep. 15, 2011

(54) SPELL-CHECKING WRITING IMPLEMENT SYSTEM AND METHOD

(76) Inventors: ALYSSA M. COLANDREO, Bow, NH (US); Brian J. Colandreo, Bow, NH (US)

(21) Appl. No.: 13/047,264

(22) Filed: Mar. 14, 2011

Related U.S. Application Data
(60) Provisional application No. 61/313,297, filed on Mar. 12, 2010.

(51) Int. Cl. G09B 5/00

(52) U.S. Cl. 434/169

(57) ABSTRACT

A spell-checking writing implement includes a microphone configured to receive a spoken word. A microprocessor is configured to execute a voice recognition process that analyzes the spoken word to define a list of one or more possible text-based matches of the spoken word. The microphone is coupled to the microprocessor. A display screen, included within the spell-checking writing implement and coupled to the microprocessor, is configured to render the list of one or more possible text-based matches of the spoken word.

### RELATED APPLICATION

This application claims the benefit of U.S. Provisional Application No.: 61/313,297, filed on 12 Mar. 2010, and entitled “Spell-Checking Writing Implement, which is herein incorporated by reference in its entirety.

### FIELD OF DISCLOSURE

This disclosure relates to writing implements and, more particularly, to spell-checking writing implements.

### BACKGROUND

Teaching a child to read and write is often a difficult challenge. Unfortunately, children quickly get frustrated and discouraged, especially when spelling errors are common. While computers may help children learn to spell by giving instantaneous feedback concerning whether a word is spelled correctly, their use is often not available. For example, when a child is learning to write, they are often using either a pen or a pencil (as opposed to a computer) and a piece of paper. Further, the skills required to use a computer are often developed after the child has initially learned to write.

### SUMMARY OF DISCLOSURE

In a first implementation, a spell-checking writing implement includes a microphone included within the spell-checking writing implement and configured to receive a spoken word. A microprocessor is configured to execute a voice recognition process that analyzes the spoken word to define a list of one or more possible text-based matches of the spoken word. The microphone is coupled to the microprocessor. A display screen, included within the spell-checking writing implement and coupled to the microprocessor, is configured to render the list of one or more possible text-based matches of the spoken word.

One or more of the following features may be included. One or more scroll buttons may allow a user to scroll through the list of one or more possible text-based matches of the spoken word. The voice recognition process may be configured to: compare the spoken word to words included within a vocabulary of the spell-checking writing implement. The display screen may be chosen from the group consisting of an LCD display screen and an LED display screen. The spell-checking writing implement may be a mechanical pencil. The spell-checking writing implement may be a pen.

In another implementation, a method includes receiving a signal indicative of a word spoken by a user into a microphone included within a spell-checking writing implement. The signal received is compared to signals that are representative of words included within a vocabulary of the spell-checking writing implement. The word spoken by the user is determined by selecting the most closely-matching word (or words) included within the vocabulary.

One or more of the following features may be included. The most closely-matching word (or words) included within the vocabulary may be rendered on a display screen. The display screen may be chosen from the group consisting of an LCD display screen and an LED display screen. The most closely-matching word (or words) may include a plurality of words and a list of the plurality of words may be scrolled through. A greeting message may be rendered on a display screen. The spell-checking writing implement may be a mechanical pencil. The spell-checking writing implement may be a pen.

In another implementation, a computer program product resides on a computer readable medium that has a plurality of instructions stored on it. When the instructions are executed by a processor, the instructions cause the processor to perform operations including receiving a signal indicative of a word spoken by a user into a microphone included within a spell-checking writing implement. The signal received is compared to signals that are representative of words included within a vocabulary of the spell-checking writing implement. The word spoken by the user is determined by selecting the most closely-matching word (or words) included within the vocabulary.

One or more of the following features may be included. The most closely-matching word (or words) included within the vocabulary may be rendered on a display screen. The display screen may be chosen from the group consisting of an LCD display screen and an LED display screen. The most closely-matching word (or words) may include a plurality of words and a list of the plurality of words may be scrolled through. A greeting message may be rendered on a display screen. The spell-checking writing implement may be a mechanical pencil. The spell-checking writing implement may be a pen.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a spell-checking writing implement.

FIG. 2 is another diagrammatic view of the spell-checking writing implement of FIG. 1.

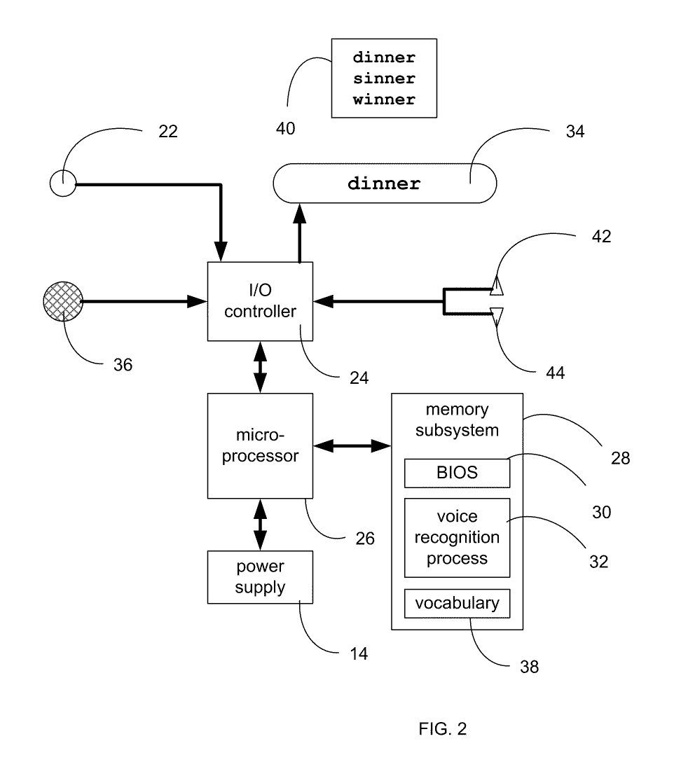

FIG. 3 is a flowchart showing the operation of the spell-checking writing implement of FIG. 1.

Like reference symbols in the various drawings indicate like elements.

### DETAILED DESCRIPTION OF THE PREFERRED EMBODIMENTS

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages.

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

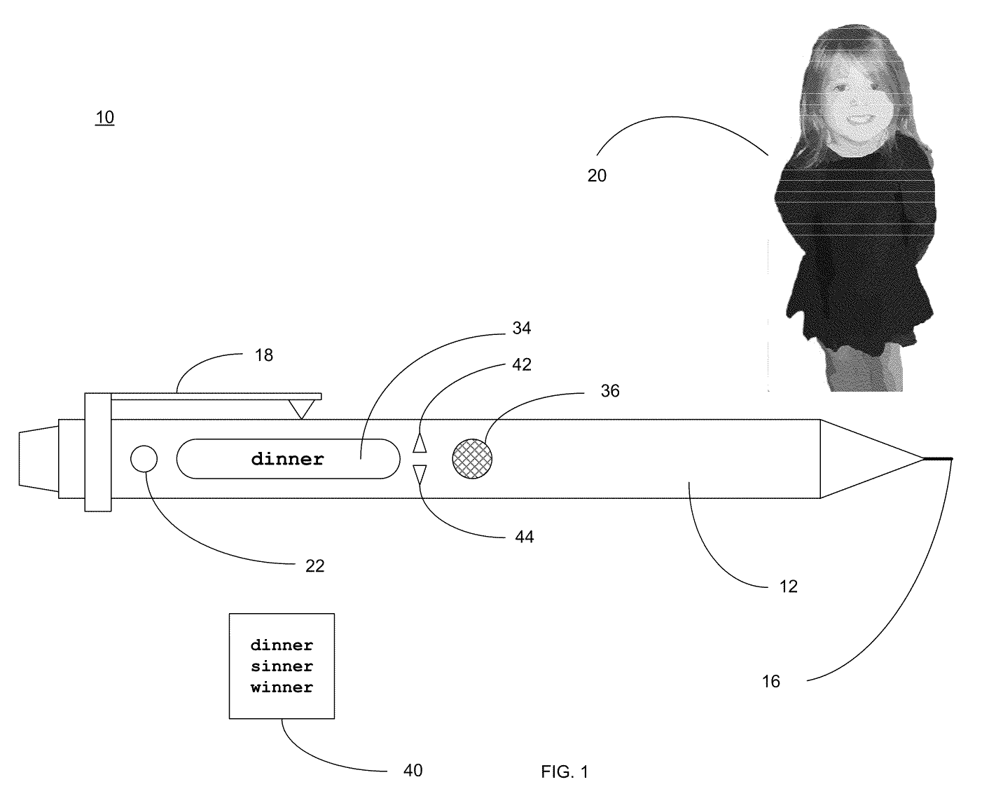

Referring to FIGS. 1 & 2, there is shown a spell-checking writing implement 10, examples of which may include but are not limited to a mechanical pencil, a ball point pen, a felt tip pen, a marker, and a fountain pen. Spell-checking writing implement 10 may include a body assembly 12 (similar to that of a traditional writing implement) configured to house the various components of spell-checking writing implement 10. Body assembly 12 of spell-checking writing implement 10 may be configured as a multi-portion body assembly to allow for the replacement of e.g., internal power supply 14 (such as a battery assembly), and ink cartridge/pencil lead 16. Body assembly 12 may be constructed of a variety of materials, such as plastic, wood and/or cast/extruded/machined metal.

Spell-checking writing implement 10 may include clip assembly 18 for allowing child 20 to clip spell-checking writing implement 10 within a pocket (not shown). Additionally/alternatively, spell-checking writing implement 10 may include a lanyard assembly (not shown) to allow spell-checking writing implement 10 to e.g., be attached to a backpack/clothing (not shown) or easily held within the hand of the child 20.

For example and for illustrative purposes only, assume that child 20 is using spell-checking writing implement 10 to write a letter (not shown) to their grandmother. Further, assume that child 20 wants to tell their grandmother about a dinner that they went to over the weekend, but they do not know how to spell the word “dinner”.

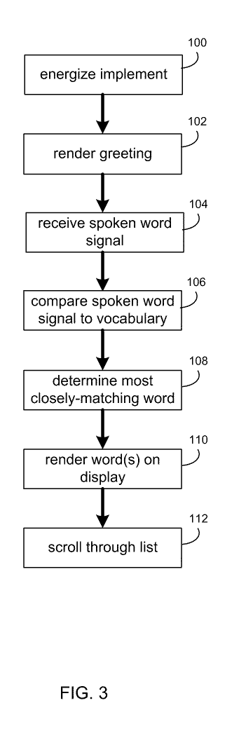

Referring also to FIG. 3, child 20 may depress power switch 22 included within spell-checking writing implement 10 to energize 100 the various components included within spell-checking writing implement 10. The depressing of power switch 22 may be sensed by IO controller 24 included within spell-checking writing implement 10, which may be coupled to microprocessor 26 also included within spell-checking writing implement 10. I/O controller 24 may be a portion of and/or included within microprocessor 26. Microprocessor 26 may be coupled to memory subsystem 28 (e.g., a computer readable medium) that may include e.g., RAM and ROM. Memory subsystem 28 may be a portion of and/or included within microprocessor 26.

Upon power switch 22 being depressed by child 20, microprocessor 26 may be energized 100 and the instruction sets and subroutines of BIOS 30 (Built-In Operating System) may be executed by microprocessor 26. BIOS 30 may be included within, stored on, and/or a portion of memory subsystem 28. Further, microprocessor 26 may execute the instruction sets and subroutines of voice recognition process 32 that may be configured to convert a word spoken by child 20 (such as “dinner”) into a text-based word. The instruction sets and subroutines of voice recognition process 32 may be included within, stored on, and/or a portion of memory subsystem 28.

Accordingly, upon microprocessor 26 being energized 100 and executing BIOS 30, microprocessor 26 may render 102 (via IO controller 24) a greeting message (not shown) on display screen 34 included within spell-checking writing implement 10 to let child 20 know that spell-checking writing implement 10 is ready to operate. Examples of this greeting message may include but are not limited to “welcome”, “ready”, “hello”, or “please speak”. Alternatively, no message may be rendered 102 and display screen 34 may be initially blank. Examples of display screen 34 may include but are not limited to an LCD (i.e., Liquid Crystal Display) display screen and an LED (i.e., Light Emitting Diode) display screen.

Once spell-checking writing implement 10 is ready for operation, child 20 may speak a word into microphone 36 included within spell-checking writing implement 10. Examples of microphone 36 may include any standard microphone (e.g., crystal microphones, condenser microphones, ribbon microphones, dynamic microphones, and carbon microphones), as well as “digital” microphones that include analog-to-digital convertors to convert the analog spoken word into a digital representation of the spoken word (thus making them directly usable by I/O controller 24 and microprocessor 26).

Continuing with the above-stated example, assume that child 20 says the word “dinner”. This spoken word will be sensed by microphone 36 and the resulting signal may be received 104 by IO controller 24 included within spell-checking writing implement 10. This signal may be provided to microprocessor 26, which may execute voice recognition process 32. As discussed above, the instruction sets and subroutines of voice recognition process 32 may be stored within memory subsystem 28.

Voice recognition process 32 may compare 106 the signal received that is e.g., representative of the spoken word “dinner” to signals that are representative of the words included within vocabulary 38 of spell-checking writing implement 10 to determine the closest match (or matches). The size of vocabulary 38 may be tailored in accordance with the anticipated vocabulary of the child who is using spell-checking writing implement 10 (e.g., child 20). For example, it is often stated that an average six-year old child has a vocabulary of approximately 5,000 words. Accordingly, the size of vocabulary 38 included within spell-checking writing implement 10 may be sized in accordance with the intended user (e.g., child 20) of spell-checking writing implement 10.

Therefore, upon voice recognition process 32 receiving 104 the signal representative of the spoken word “dinner”, voice recognition process 32 may compare 106 the signal received to signals that are representative of the words included within vocabulary 38 of spell-checking writing implement 10 to determine the closest match (or matches). For example, a digitized representation of the spoken word “dinner” may be compared 106 to a digitized representation of each of the words included within vocabulary 38 of spell-checking writing implement 10. Examples of voice recognition process 32 may include voice recognitions processes such as Dragon Naturally Speaking™ that is offered by Nuance™ of Burlington, Mass.

Upon making the comparison, voice recognition process 32 may determine 108 the word spoken by child 20 by selecting the most closely-matching word (or words) included within vocabulary 38. For example, assume for illustrative purposes that child 20 spoke clearly enough so that it was satisfactorily clear to voice recognition process 32 that the word spoken by child 20 was “dinner”. Accordingly, voice recognition process 32 may render 110 (via microprocessor 26 and IO controller 24) the text-based word “dinner” within display screen 34. Accordingly, child 20 may now read the correct spelling of the spoken word “dinner” from display screen 34 and write the same via spell-checking writing implement 10.

Additionally/alternatively, assume that child 20 pronounces the word “dinner” in a manner that results in voice recognition process 32 being less than certain concerning the identification of the word spoken by child 20. Alternatively, the word spoken by child 20 may be similar in pronunciation to a plurality of words included within vocabulary 38 of spell-checking writing implement 10. An example may include the word “dinner” when compared to the words “winner” and “sinner”. Accordingly, voice recognition process 32 may not be able to unambiguously determine 108 the word spoken by child 20. Therefore, voice recognition process 32 (via microprocessor 26 and IO controller 24) may render 110 a text-based list of possible matches 40 on display screen 34. An example of list 40 may include but is not limited to a list that identifies “dinner”, “winner” and “sinner”. Child 20 may then scroll 112 through list of possible matches 40 until they see the correct word. Scrolling 112 through list of possible matches 40 may be accomplished via scroll up button 42 and scroll down button 44 (in combination with microprocessor 26 and IO controller 24) that are included within spell-checking writing implement 10.

In the event that child 20 subsequently wishes to determine the spelling of a new word, child 20 may simply cycle power switch 22, thus resetting spell-checking writing implement 10. Further, spell-checking writing implement 10 may include an internal time (not shown) that is configured to automatically turn off spell-checking writing implement 10 after a defined period of time (thus extending the life of power supply 14).

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A spell-checking writing implement comprising:
a microphone included within the spell-checking writing implement and configured to receive a spoken word;
a microprocessor configured to execute a voice recognition process that analyzes the spoken word to define a list of one or more possible text-based matches of the spoken word, wherein the microphone is coupled to the microprocessor; and
a display screen included within the spell-checking writing implement and coupled to the microprocessor, the display screen being configured to render the list of one or more possible text-based matches of the spoken word.

2. A spell-checking writing implement of claim 1 further comprising:
one or more scroll buttons that allow a user to scroll through the list of one or more possible text-based matches of the spoken word.

3. A spell-checking writing implement of claim 1 wherein the voice recognition process is configured to:
compare the spoken word to words included within a vocabulary of the spell-checking writing implement.

4. A spell-checking writing implement of claim 1 wherein the display screen is chosen from the group consisting of an LCD display screen and an LED display screen.

5. A spell-checking writing implement of claim 1 wherein the spell-checking writing implement is a mechanical pencil.

6. A spell-checking writing implement of claim 1 wherein the spell-checking writing implement is a pen.

7. A method comprising:
receiving a signal indicative of a word spoken by a user into a microphone included within a spell-checking writing implement;
comparing the signal received to signals that are representative of words included within a vocabulary of the spell-checking writing implement; and
determining the word spoken by the user by selecting the most closely-matching word (or words) included within the vocabulary.

8. The method of claim 7 further comprising:
rendering the most closely-matching word (or words) included within the vocabulary on a display screen.

9. The method of claim 8 wherein the display screen is chosen from the group consisting of an LCD display screen and an LED display screen.

10. The method of claim 8 wherein the most closely-matching word (or words) includes a plurality of words, the method further comprising:
scrolling through a list of the plurality of words.

11. The method of claim 7 further comprising:
rendering a greeting message on a display screen.

12. The method of claim 7 wherein the spell-checking writing implement is a mechanical pencil.

13. The method of claim 7 wherein the spell-checking writing implement is a pen.

14. A computer program product residing on a computer readable medium having a plurality of instructions stored thereon, which, when executed by a processor, cause the processor to perform operations including:
receiving a signal indicative of a word spoken by a user into a microphone included within a spell-checking writing implement;
comparing the signal received to signals that are representative of words included within a vocabulary of the spell-checking writing implement; and
determining the word spoken by the user by selecting the most closely-matching word (or words) included within the vocabulary.

15. The computer program product of claim 14 further comprising instructions for performing operations including:
rendering the most closely-matching word (or words) included within the vocabulary on a display screen.

16. The computer program product of claim 15 wherein the display screen is chosen from the group consisting of an LCD display screen and an LED display screen.

17. The computer program product of claim 15 wherein the most closely-matching word (or words) includes a plurality of words, the method further comprising instructions for performing operations including:
scrolling through a list of the plurality of words.

18. The computer program product of claim 14 further comprising instructions for performing operations including:
rendering a greeting message on a display screen.

19. The computer program product of claim 14 wherein the spell-checking writing implement is a mechanical pencil.

20. The computer program product of claim 14 wherein the spell-checking writing implement is a pen.
